(19) United States
(12) Patent Application Publication
(10) Pub. No.: US 2005/0102669 A1
(43) Pub. Date: May 12, 2005

(54) Software installation file verification media and methods for medical equipment

(75) Inventors: Christian H. Marney, Issaquah, WA (US); Michael J. Roseleip, Kent, WA (US); Ray W. Graves, North Bend, WA (US)

Correspondence Address: SIEMENS CORPORATION;INTELLECTUAL PROPERTY DEPARTMENT, 170 WOOD AVENUE SOUTH, ISELIN, NJ, 08830, US

(73) Assignee: Siemens Medical Solutions USA, Inc.

(21) Appl. No.: 10/949,414

(22) Filed: Sep. 24, 2004

Related U.S. Application Data
(60) Provisional application No. 60/511,907, filed on Oct. 15, 2003.

(51) Int. Cl. G06F 9/46

(52) U.S. Cl. 717/174

(57) ABSTRACT

File verification is provided for medical imaging systems, other medical systems or other systems. The verification is performed on an install media prior to installation. For example, data for an upgrade package is transmitted over a computer network. The data is then copied to a compact disc or the RAM of a system to be updated. The copy on the compact disc or the RAM of the system to be updated is verified. Multiple verifications may be performed, such as verifying received data before copying to an install media, verifying on an install media remote from a system to be updated, and verifying on the system to be updated. The verification may be performed separately for each of a plurality of different files in an upgrade package or on an install media. In one embodiment, an MD5 algorithm is used for verification.

### REFERENCE TO RELATED APPLICATIONS

The present patent document claims the benefit of the filing date under 35 U.S.C. §119(e) of Provisional U.S. Patent Application Ser. No. 60/511,907, filed Oct. 15, 2003, which is hereby incorporated by reference.

### BACKGROUND

The present invention relates to software installation file verification. In particular, the correctness of copied data is verified.

Cyclic Redundancy Codes (CRC) are used for error detection of transmitted messages. A checksum is calculated as a function of the message to be transmitted. One example of a checksum is the sum of the bytes of the message in modulo 256. More complex checksums may be provided, such as checksum tables or other values derived using polynominal arithmetic. The checksum is appended to the message. The receiver then uses the same function to calculate the checksum of the received message for comparison with the appended checksum. If the checksums match, then the message received is correct or verified. CRC-based algorithms result in data that may not be unique to a particular message.

More complex algorithms are used for encryption. For example, a digital finger print is generated using a Message Digest algorithm, such as MD5. It may be computationally infeasible to produce two messages having the same message-digest or to produce any message having a given pre-specified target digest. Where a large file is compressed in a secure manner before being encrypted with a private secret key under a public key cryptosystem, such as RSA, the algorithm is used to obtain a digital signature.

The MD5 algorithm has been used for file verification. An iso-image representing a compact disc file of the data is transmitted to a processor. The digital signature associated with the iso-image file is also transmitted. The MD5 algorithm is run on the received data. If the digital signatures match indicating the data is correct, the ISO file is copied to or used to create a compact disc. The compact disc is then used to upgrade one or more medical systems.

### BRIEF SUMMARY

By way of introduction, the preferred embodiments described below include methods and computer readable media for software installation file verification. File verification is provided for medical imaging systems, other medical systems or other systems. The verification is performed on an install media prior to installation. For example, data for an upgrade package is transmitted over a computer network. The data is then copied to a compact disc or the RAM of a system to be updated. The copy on the compact disc or the RAM of the system to be updated is verified. Multiple verifications may be performed, such as verifying received data before copying to an install media, verifying on an install media remote from a system to be updated, and verifying on the system to be updated. The verification may be performed separately for each of a plurality of different files in an upgrade package or on an install media. In one embodiment, an MD5 algorithm is used for verification. These various aspects may be used alone or in combinations.

In a first aspect, a method is provided for enabling field upgrades of a medical imaging system. An upgrade package is electronically transmitted. Install media including the upgrade package is created. Whether or not the upgrade package on the install media is correct is determined with an error detection code.

In a second aspect, a method is provided for enabling field upgrades of a medical imaging system. An upgrade package is electronically transmitted to an installer. The electronically transmitted upgrade package is saved to storage media. At least a portion of the transmitted package is verified using only data from the saved transmitted upgrade package.

In a third aspect, a method is provided for verifying software installation files. A package having a plurality of installation files and a respective plurality of error detection codes is provided. Whether each of the plurality of installation files is correct is separately verified with respective error detection codes prior to installation. The verified package is installed.

In a fourth aspect, a method is provided for verifying software installation files of a medical system. An upgrade package and verification code are transmitted over the Internet. The upgrade package and verification code are received. A verification algorithm is applied to the upgrade package at two different locations. The results of the application of the verification algorithm are compared with the verification code. Installation of the upgrade package on the medical system is allowed if the results and the verification code match.

In a fifth aspect, a method is provided for verifying software installation files of a medical system. An upgrade package for medical system and a message-digest algorithm digital signature for the upgrade package are provided. A message-digest algorithm is applied to upgrade package. The results of the application of the message-digest algorithm are compared with the message-digest algorithm digital signature. The upgrade package is installed on the medical system if the result matches the message-digest algorithm digital signature.

In a sixth aspect, a computer readable storage medium having data stored therein representing instructions executable by a processor to upgrade software on a medical system is provided. The instructions include instructions for applying an error detection algorithm to data stored on the computer readable storage medium; determining a first digital signature of the data in response to the application of the error detection algorithm; comparing the first digital signature to a second digital signature stored on the computer readable storage medium; and allowing installation using the data where the first digital signature matches the second digital signature.

The present invention is defined by the following claims, and nothing in this section should be taken as a limitation on those claims. Further aspects and advantages of the invention are discussed below in conjunction with the preferred embodiments and may be later claimed independently or in combination.

### BRIEF DESCRIPTION OF THE DRAWINGS

The components in the figures are not necessarily to scale, emphasis instead being placed upon illustrating the principles of the invention. Moreover, in the figures, like reference numerals designate corresponding parts throughout the different views.

FIG. 1 is a block diagram of one embodiment of a system for verifying software installation files;

FIG. 2 is a flowchart diagram of one embodiment of a method for verifying software installation files; and

FIG. 3 is a flowchart diagram of one embodiment of a method for upgrading a system.

### DETAILED DESCRIPTION OF THE DRAWINGS AND PRESENTLY PREFERRED EMBODIMENTS

One or more files stored on an install media are verified prior to installation. By verifying a data prior to installation, proper installation may be more likely. In medical imaging systems, timely operability of the device may be important. By verifying software files prior to installation, the medical device is more likely to avoid downtime or other problems in operation. The software installation data may be provided using data from a remote source. Verification assures correct information is received for installation. Since copying to the install media from buffers, compact discs or other storage devices may cause errors, verification is performed on the install media prior to installation. The verification may additionally or alternatively be performed at other times or locations along the data path. In one embodiment, a message-digest based algorithm, such as MD5, is used, but other algorithms may be provided.

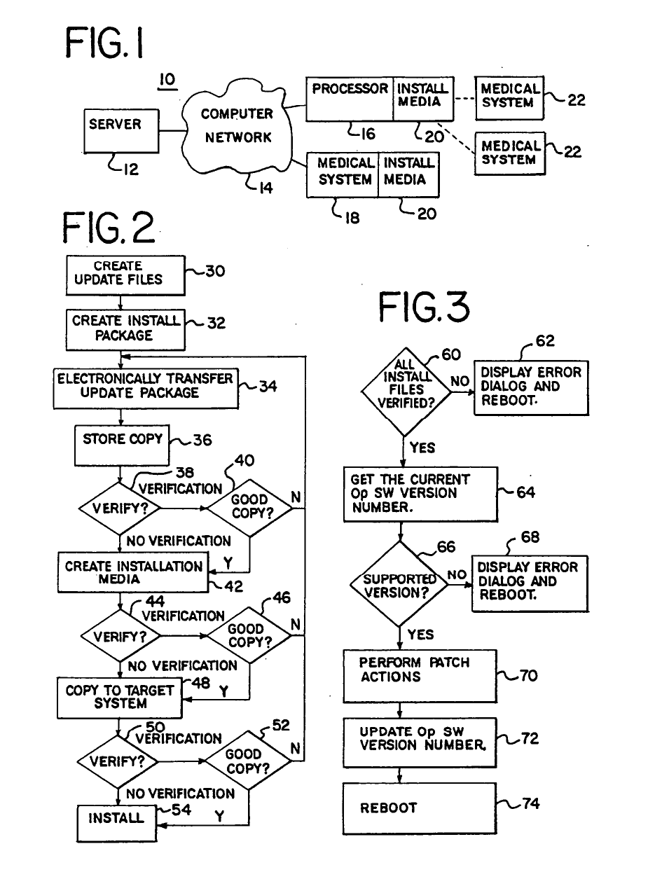

FIG. 1 shows one embodiment of a system 10 for verifying software installation files. The system 10 includes a server 12, computer network 14, processor 16, medical system 18, install media 20 and medical systems 22. Additional, different or fewer components may be provided, such as connecting the server 12 directly to or through portable media to the processor 16 and/or medical system 18 without the computer network 14. As another example, the system 10 includes the processor 16 but not the medical system 18 or vice versa. The system 10 is used as part of a medical system network, such as a network of medical imaging systems, medical diagnostic systems or other medical systems. Other networks, such as a network of workstations, personal computers, servers, routers and/or other devices for medical or non-medical applications may be used.

The server 12 is a processor, computer, router, database or other source of software. Software includes data files, such as tables, operating systems, object code, text files, scripts, data files, application software files, firmware, updates, combinations thereof or other digital information. In one embodiment, the server 12 is operated by a medical system provider, but may be operated by a third party or by a user of medical systems. The server 12 provides software for updating other systems, such as the medical systems 22, the processor 16 and/or the medical systems 18. The server 12 connects with other systems through the computer network 14.

The computer network 14 is a local area network, a wide area network, the Internet or other network. The computer network 14 allows electronic transmission of software data from the server 12 to other systems. In alternative embodiments, the server 12 connects directly to the other systems, such as using a modem link. In yet other embodiments, the server 12 provides the software files by copying to a compact disc, digital video disc, magnetic optical medium or other portable storage device. The portable storage device is then provided to the other systems.

The processor 16 is a personal computer, workstation, server, database, or other now known or later developed device for receiving software and copying the software to the install media 20. In one embodiment, the processor 16 is a device owned by an installer or service technician. For example, a service representative is responsible for the software or other operation of one or more systems. The service representative is associated with the owners of the medical system, is a third party contracted to maintain the systems or is an employee of the manufacturer of such systems. In another embodiment, the processor 16 is operated or contracted by a facility, such as a hospital or group of hospitals operating one or more medical systems.

In an alternative or additional embodiment, the software data is provided directly to a medical system 18, or a workstation or other processor adapted to interface with the medical system 18. The user of the medical system 18 or corresponding workstation may then install the software with or without an additional operator or installers using a processor of the medical system 18. The medical system 18 and/or systems 22 are medical diagnostic imaging systems, such as an ultrasound, x-ray, computed tomography, records workstations, personal computers, magnetic resonance imaging, combinations thereof or other imaging system. Non-medical systems or non-imaging systems may also be used, such as a medical therapy system or a record system (e.g., PACS).

The install media 20 is a storage device used for installing the software on the system. The install media 20 is a compact disc, digital video disc, system random access memory, magnetic optical disc, system memory, memory stick, hard drive, combinations thereof or other now known or later developed portable or non-portable memory. For example, the install media 20 associated with the medical system 18 is a system memory of a workstation associated with the medical system 18 or of the medical system 18. As another example, the install media 20 associated with the processor 16 is a compact disc, digital video disc, magnetic optical memory, memory stick or other memory device for being portably carried to other systems 22 as represented by the dashed-line connections. Upgrade packages of updates or new software are then installed from the install media 20 into the medical system 18, 22 or other systems. Using the intermediate processor 16, the install media 20 is used to communicate the software to the other medical systems 22. Software may be installed directly from the install media into the other medical systems 22 or may be copied to a system memory of the systems 22 for installation.

The system 10 provides for software installation in two different environments. In one environment, software is provided to one or more systems for installation on the systems. In another environment, the software is provided to a service representative for copying to an install media. The service representative may then install the software on one or more systems. Other environments may be provided, such as mailing portable install media to a plurality of users, service representatives or technicians. By providing electronic transmission, more rapid, cost effective and efficient installation upgrades may be provided.

To verify that the correct data received for installation is correct, the verification algorithm and associated error detection code are transmitted or provided to the processor 16, the medical system 18, install media 20 and/or medical systems 22. The algorithms and/or the error detection code are provided with the software, such as within a same transmission, or separate from the software. For example, the error detection algorithm is previously loaded into the device prior to receiving any software files for installation. The verification is performed at one or more locations within the system 10, such as at the processor 16, on the install media 20 while remote from the medical systems 22 or while connected with the medical systems 22 and/or after the software is copied to a system memory of one or more of the medical systems 22.

FIG. 2 shows one embodiment of a method for verifying software installation files. The method enables field updates or original installation of upgrade files on any of various systems, such as medical imaging systems. The method is implemented using the system 10 shown in FIG. 1 or a different system. Additional, different or fewer acts may be provided. For example, the method is performed free of the electronic transfer of act 34. As another example, one or two of the verification acts 38, 44 and 50 are not performed. The method as shown in FIG. 2 represents the data path for installing an upgrade package or patch using an intermediate install media. Other data paths may be provided, such as by altering the number or location of the verifications.

In act 30, update, original or other upgrade software files are created. The files created include files associated with third party software, such as drivers, files associated with a particular system and/or firmware, such as FPGA. For example, a programmer at a manufacturer of medical systems creates a table, a database, an application, a bug fix, or other files to correct, alter, replace or add to the medical system or already installed software. One or more files are created. For example, a plurality of files associated with different applications or different portions of a same application are created. For medical imaging systems, the files correspond to imaging, communications, storage or other processes performed by a medical imaging system. For example, a file is generated as a table for a beamformer configuration and a corresponding imaging processing file for programming a filter or operating a processor to filter image data is also provided.

In act 32, an installation or upgrade package is created. The upgrade package includes one or a plurality of installation files. The upgrade package is a service pack of installation files. Installation files correspond to operating system security fixes, application processing fixes, database fixes, bug or error removals, adding additional features, or other software. The upgrade package generated may include system check software to verify system hardware and software compatibility with the update package, installation programs and/or scripts. The various files associated with a same upgrade or different upgrades to be performed at a similar time are packaged together. Packaging may include collecting the information for transmission at a substantially same time or inclusion within a same patch. The upgrade package is provided as an iso-image, separate files, a patch or other format.

The upgrade package also includes one or more error detection codes. An error detection code is generated for one or more of the files within an upgrade package. A message-digest algorithm, CRC algorithm or other algorithm is applied to the files to generate the error detection code. A CRC, MD5 or other error detection code is used. A digital signature, digital fingerprint, checksum, or other information is placed in a file with reference to the corresponding files from which the error detection code was generated. Alternatively, a single error detection code is generated for the collection of files, such as generating the error detection code for an iso-image of the entire upgrade package. The upgrade package additionally includes the error detection algorithm used for generating the codes. Alternatively, the codes and/or the error detection algorithm are appended to the files of the upgrade package or other installation software.

As represented in the flowchart of FIG. 2, the upgrade or installation package is created at a manufacturer or remote from other systems. Alternatively, the installation or upgrade package 32 is created by an installer or service technician or provided at a medical device. For example, a user of a medical imaging system generates a new application or an upgrade of an existing application. The installation file is then provided at the medical imaging device.

In act 34, the upgrade package is electronically transmitted. Electronic transfer includes transferring the files to another or same physical location by the computer network, email, wireless or other electronic transmission. The electronic transmission is performed over a computer network. For example, the upgrade package with the verification or error detection code is transmitted over the Internet from a manufacturer or other source to a medical system or other processor. The transmission is performed pursuant to TCP/IP protocols, but other network transmission of packets or a data stream may be used. The object code of the upgrade package and digital signatures, checksums or other codes corresponding to at least a portion of the upgrade package are transmitted together or separately. Where the upgrade package includes a plurality of installation files, a respective plurality of error detection codes are also transmitted as appended to each of the files or separately. The package with the plurality of files and codes is transmitted as an iso-image format, but other formats may be used. Rather than having an error detection code for each file within an upgrade package, a single error detection code may be provided for multiple files.

The transmission is performed with or without compression. For example, a loss-less compression algorithm compresses the upgrade package. Any now known or later developed loss-less compression algorithm may be used, such as Huffman encoding, Lempel-Ziv-Welch (LZW) compression, or ZIP compression (e.g., WinZip compression algorithm). The entire or only portions of the upgrade package are compressed. The upgrade package is uncompressed upon receipt, and then verified. Alternatively, at least one version of the upgrade package in a compressed form is verified, such as before installation. The digital signature is determined on the compressed upgrade package.

The transmission of act 34 is provided to an installer, directly to a medical system, or directly to a network connected with a medical system. The installer is either a user, a service representative, medical imaging system, or a workstation adapted to interface with the medical imaging system. For example, the upgrade package is transmitted to a workstation in a local area network connected with a plurality of medical imaging systems. An installer then causes the upgrade package to be installed on one or more of the medical systems. As another example, the upgrade package is transmitted to a third party. The third party creates install media. The install media is then used by the third party to install the upgrade package on one or more medical or other systems.

In act 36, a copy of the upgrade package is stored. A copy of the upgrade package is stored in a buffer or memory associated with a processor which receives the upgrade package. The upgrade package and the corresponding verification code are received from the electronic transmission and stored. The electronic transmission is sent to and received by either a processor separate from systems to be upgraded or by the system to be upgraded, such as receiving the upgrade package and verification code at a medical system. In alternative embodiments, the copy is received from a transfer of data from a storage medium, such as from a compact disc rather than an electronic transfer over a computer network.

In optional act 38, at least a portion of the upgrade package is verified. Where both the error detection or verification code and the installation files are included within the transmitted package, only data from the stored upgrade package is used for verification in act 38. Verification is performed by applying a message-digest algorithm or other error detection algorithm to the upgrade package or a portion of the upgrade package. Where an error detection code corresponds to an iso-image of the entire upgrade package, the algorithm is applied to the complete upgrade package. The algorithm may also be applied to the complete upgrade package by applying it to each of the component files within the upgrade package in two or more groups. Separate application for different files allows verification of correct receipt of each individual file or groups of files prior to installation. Error detection codes may be provided for both the iso-image file as well as separate files within the installation package.

The verification of act 38 is optional. Where the verification of act 38 is performed, the process proceeds to act 40 for determining whether the data is correct. Where verification is not provided, the process proceeds to act 42.

In act 40, the error detection code is used to determine whether or not the upgrade package received and stored in act 36 is correct. A result of the verification algorithm applied in act 38 is compared to the error detection code. For example, the result of application of the MD5 algorithm is a digital signature or MD5 code. The MD5 code generated on the stored copy is compared to the transmitted error detection code. By comparing the current signature to a digital signature, correct transmission may be verified. If the error detection codes match, a good copy is provided. Where the error detection codes are different, another transfer of the update package is requested electronically or through other communications.

The verification of acts 38 and 40 are performed prior to creating install media in act 42. In act 42, install media is created. The install media is created with the processor that received an electronic transmission in act 34. The install media is created by saving the upgrade package to storage media. For example, a digital video disc, compact disc, magnetic optical disc, file disposed in a system memory, or a file disposed in a memory external to a system is created. Where the upgrade package is provided as an iso-image, the installed media is created from the iso-image. The install media is portable, such as a compact disc, video disc or magnetic optical disc or tape or any other medium. Alternatively, the install media is a memory of a system, such as a memory associated with the system to be upgraded.

The install media includes the files to be installed, such as the installation files. The install media may also include a copy of error detection code or codes. In one embodiment, the error detection algorithm is also provided on the install media. Providing the digital signature or other error detection code as well as the error detection algorithm allows verification on the install media without other sources of information. Alternatively, the error detection code and/or error detection algorithm are provided separately from the install media for verification of the install media.

The install media provides a copy of the files from the upgrade package to be used for installing the software. For example, the iso-image file is converted into a media file, such as a compact disc file, to be used for installing software.

The install media is a computer readable storage medium having data stored thereon that represents instructions executable by a processor to upgrade software or install software on a system, such as a medical system. Where the install media is a portable medium, the instructions are operable with data on the portable medium for transferring to a system memory and installing. Where the install media is a memory of the system to which software is going to be installed, the instructions are operable to perform the installation.

In addition to instructions for installing the software, instructions are provided for verification. Instructions for applying an error detection algorithm to data stored on the computer readable storage media are provided. By applying the error detection algorithm, a digital signature or other error detection code is determined. The digital signature is compared with a previously generated digital signature also stored on the computer readable storage medium or on a separate medium. The installation or further data transfer may then be allowed using the data from the computer readable storage medium where the digital signatures match, indicating a correct copying or creation of the install media.

The error detection algorithm and corresponding instructions for performing the algorithm are also stored on the computer readable medium. For example, a message-digest algorithm is stored. Alternatively, the algorithm is stored separately. The digital signature is stored on the computer readable medium. The code corresponds to one file, a plurality of files or the entire upgrade package. Alternatively, a plurality of error digital signatures corresponding to a plurality of groups of one or more files within an upgrade package is stored. The instructions provide for application of the error detection algorithm, determination of a digital signal or error code in comparing the stored codes with the current generated codes for each of the files.

In act 44, one or more files, such as the entire upgrade package as a single file or a plurality of individual installation files of the upgrade package as stored on the install media are verified. The verification is performed in a same or similar manner to the verification of 38. Since the creation of install media may result in data errors, the verification is performed on the data on the install media.

In act 46, error detection codes previously generated are used to determine whether or not the upgrade package of files on the install media is correct. The verification is performed prior to any installation from the install media. By applying a verification algorithm, a current signature of the data as stored on the install media is compared to a previously generated signature. For example, a MD5 error correction code generated in act 32 is compared with a currently generated MD5 error detection code. If the digital signatures match, the process proceeds to allow installation or copying to a target system. If the codes fail to match, the process proceeds to recreation of the install media in act 42 or to a request for another transfer of the update package in act 34.

Verification of the install media occurs at a remote location from the systems to be upgraded or for which this software is intended in one embodiment. For example, an installer receives the upgrade package and creates the install media, such as burning a compact disc or digital video disc. By verifying that the install media is correct prior to traveling to another system for installation, unnecessary hassles may be avoided. Alternatively, the verification of the install media occurs at the system to be upgraded. For example, the verification is performed on the upgrade package as stored on a medical system in a system memory prior to performing an installation. By performing the verification on the install media, correct transmission as well as copying to the install media may be assured. Downtime or incorrect operation of the medical imaging system or system may more likely be avoided.

In act 48, the installation files from the install media are copied to a target system, such as a medical imaging system. Where the install media is a portable memory other than a system memory or memory used by a system for installing files, act 48 is performed. Rather than copying an iso-image, the specific files for installation are copied. In optional acts 50 and 52, the copied files are again verified. The system memory or other memory of the target system is a secondary or primary install media. The upgrade package verified in act 38 may be an iso-image without separate installation files until creation of the install media. Alternatively, the verifications of acts 38, 44 and 50 operate on the same data, such as one or more installation files. After performing one or more of the verifications, such as the verification in act 50 and 52, installation of the upgrade package is allowed on the system. If the result of an error detection algorithm and a verification or error code do not match, the process moves to acts 34, act 48 or act 42.

Where installation is allowed through verification, the upgrade package is installed in act 54. For example, a message-digest algorithm digital signature generated at the creation of the installation files or an update package in acts 30 or 32 matches a message-digest algorithm digital signature generated from installation files in act 50. The medical imaging system or other system is upgraded or has software installed. The upgrade package is installed from the install media, such as a system memory or removable, portable storage.

FIG. 3 shows one embodiment of a method for installing data on a system, such as a medical imaging system. The installation occurs at the system, such as installing software from a removable, portable memory device or from a system memory. Alternatively, software is installed from remote device, such as over a computer network. Additional, different or fewer acts may be provided.

In act 60, the installation files are verified. Each of the files within an upgrade package is separately verified or is verified in two or more groups. Alternatively, the files are verified as a single group. In yet another embodiment, an entire upgrade package is verified as an iso-image.

Where one or more of the files are not verified, an error message is displayed and the system is rebooted in act 62. In medical imaging systems, software may be shutdown or closed at the beginning of an installation process, such as prior to verification. If the software is not verified, then the medical imaging system software or operating system is reloaded by rebooting. Act 62 is optional. Where an operating system or other software remains open, act 62 may include the display of an error message without rebooting.

Where the installation files are verified in act 60, the current operating software version number is obtained in act 64. Current software version numbers for other applications other than the operating system may alternatively be obtained. In act 66, the version number is compared to determine whether the version is supported by the upgrade package. If the version is unsupported, an error is displayed and the system is rebooted in optional act 68. If the version is supported, then software is installed in acts 70. The version number is updated in act 72, and the system is rebooted in act 74.

An additional optional verification may be performed after installation. An error detection code corresponding to the upgraded, updated or installed software is provided. The verification algorithm is applied to the installed software. If the codes match, the process is complete. If the codes mismatch, an error signal may be provided and/or software upgrades or files uninstalled.

The terms “coupled” and “connected” include both direct as well as indirect mechanical or electrical connections.

While the invention has been described above by reference to various embodiments, it should be understood that many changes and modifications can be made without departing from the scope of the invention. It is therefore intended that the foregoing detailed description be regarded as illustrative rather than limiting, and that it be understood that it is the following claims, including all equivalents, that are intended to define the spirit and scope of this invention.

1. A method for enabling field upgrades of a medical imaging system, the method comprising:
(a) electronically transmitting an upgrade package;
(b) creating install media comprising the upgrade package; and
(c) determining with an error detection code whether or not the upgrade package on the install media is correct.

2. The method of claim 1 wherein (b) and (c) are performed by an installer at a location remote from the medical imaging system;
further comprising:
(d) installing the upgrade package on the medical imaging system from the install media.

3. The method of claim 1 wherein (a) comprises transmitting to an installer, wherein the installer is one of a user, a service representative, the medical imaging system, and a workstation adapted to interface with the medical imaging system.

4. The method of claim 1 wherein (b) comprises creating one of a digital video disk, compact disk, magnetic optical disk, a file disposed in a system memory, and a file disposed in a memory external to the medical imaging system.

5. The method of claim 1 wherein (b) comprises creating the install media comprising the error detection code and an error detection algorithm.

6. The method of claim 1 wherein (a) comprises transmitting a digital signature corresponding to at least a portion of the upgrade package with the upgrade package, and wherein (b) comprises including the digital signature on the install media, the digital signature being the error detection code.

7. The method of claim 6 wherein (c) comprises:
(c1) determining a current signature of the upgrade package on the install media; and
(c2) comparing the current signature to the digital signature.

8. The method of claim 6 wherein (a) comprises transmitting over a computer network.

9. The method of claim 1 wherein (a) comprises transmitting object code of the upgrade package.

10. The method of claim 1 wherein (a) comprises transmitting the upgrade package over a computer network to the medical imaging system, wherein (b) comprises storing the upgrade package in a memory of the medical imaging system, and wherein (c) comprises verifying whether or not the upgrade package on the memory is correct prior to installation.

11. The method of claim 1 wherein (c) comprises determining with the error correction code, the error correction code being a message-digest 5 algorithm.

12. The method of claim 1 wherein (a) comprises transmitting the upgrade package having a plurality of files and a respective plurality of error detection codes, and wherein (c) is performed separately for each of the plurality of files with the respective one of the plurality of detection codes.

13. The method of claim 12 wherein (a) comprises transmitting an iso-image, and wherein (b) comprises creating the install media from the iso-image.

14. A method for enabling field upgrades of medical imaging system, the method comprising:
(a) electronically transmitting an upgrade package to an installer;
(b) saving the electronically transmitted upgrade package to storage media; and
(c) verifying that at least a portion of the transmitted package is correct using only data from the saved transmitted upgrade package.

15. The method of claim 14, wherein the portion of the transmitted package is the complete upgrade package.

16. A method for verifying software installation files, the method comprising:
(a) providing a package having a plurality of installation files and a respectively plurality of error detection codes;
(b) separately verifying with respective error detection codes whether each of the plurality of installation files is correct prior to installation; and
(c) installing the package.

17. The method of claim 16 wherein (a) comprises transmitting the upgrade package over a computer network.

18. The method of claim 16 further comprising:
(d) receiving the upgrade package at a first processor;
(e) creating install media with the first processor; and
(f) performing (b) on the installation files of the install media.

19. The method of claim 16 wherein (a) comprises providing the upgrade package with an error detection algorithm, and wherein (b) comprises performing the verification with the error detection algorithm.

20. A method for verifying software installation files of a medical system, the method comprising:
(a) transmitting an upgrade package and verification code over the Internet;
(b) receiving the upgrade package and verification code;
(c) applying a verification algorithm to the upgrade package after (b) and at two or more different locations;
(d) comparing a result of (c) with the verification code; and
(e) allowing installation of the upgrade package on the medical system if the result and the verification code match.

21. The method of claim 20 wherein (b) comprises receiving the upgrade package and verification code at a first location;
further comprising:
(f) creating install media with the upgrade package at the first location;
(g) transferring the install media from the first location to the medical system; and
(h) installing the upgrade package on the medical system.

22. The method of claim 21 wherein (c) and (d) are performed on the upgrade package stored on the install media at the first location.

23. The method of claim 21 wherein (c) and (d) are performed on the upgrade package stored on the medical system prior to performing (h).

24. The method of claim 20 wherein (b) comprises receiving the upgrade package and verification code at the medical system and performing (c) and (d) on the upgrade package stored on the medical system prior to installation.

25. A method for verifying software installation files of a medical system, the method comprising:
(a) providing an upgrade package for the medical system and a message-digest algorithm digital signature for the upgrade package;
(b) applying a message-digest algorithm to the upgrade package;
(c) comparing the result of (b) with the message-digest algorithm digital signature; and
(d) installing the upgrade package on the medical system if the result matches the message-digest algorithm digital signature.

26. A computer readable storage medium having data stored therein representing instructions executable by a computer to upgrade software on a medical system, the instructions comprising instructions for:
apply an error detection algorithm to data stored on the computer readable storage medium;
determine a first digital signature of the data in response to the application of the error detection algorithm;
compare the first digital signature to a second digital signature stored on the computer readable storage medium; and
allow installation using the data where the first digital signature matches the second digital signature.

27. The instructions of claim 26 wherein the computer readable storage medium comprises a memory of the medical system.

28. The instructions of claim 26 wherein the computer readable storage medium comprises a portable medium, the instructions operable with the data on the portable medium and data transferred to a system memory.

29. The instructions of claim 26 further comprising instructions for performing the error detection algorithm, the instructions being a message-digest algorithm.

30. The instructions of claim 26 wherein the data comprises a plurality of files, the first error digital signature corresponding to one of the plurality of files, further comprising instructions for applying, determining and comparing for each of the files.

31. The method of claim 8 wherein (a) comprises transmitting the upgrade package as loss-less compressed data.

32. The method of claim 17 wherein (a) comprises transmitting the upgrade package as loss-less compressed data.

33. The method of claim 20 wherein (a) comprises transmitting the upgrade package as loss-less compressed data.
